(19) United States
(12) Patent Application Publication
(10) Pub. No.: US 2024/0284388 A1
(43) Pub. Date: Aug. 22, 2024

(54) SYSTEMS AND METHODS FOR COMMUNICATING REFERENCE SIGNALS FOR POSITIONING

(71) Applicant: ZTE Corporation, Shenzhen (CN)

(72) Inventors: Yu PAN, Shenzhen (CN); Chuangxin JIANG, Shenzhen (CN); Guozeng ZHENG, Shenzhen (CN)

(73) Assignee: ZTE Corporation, Shenzhen (CN)

(21) Appl. No.: 18/606,061

(22) Filed: Mar. 15, 2024

Related U.S. Application Data
(63) Continuation of application No. PCT/CN22/70926, filed on Jan. 10, 2022.

(51) Int. Cl. H04W 64/00; H04L 5/00; H04W 76/20

(52) U.S. Cl. CPC H04W 64/00; H04L 5/0051; H04W 76/20

(57) ABSTRACT

Presented are systems and methods for reference signals communication for positioning. A wireless communication device can receive a first message indicating a plurality of Sounding Reference Signal (SRS) aggregates, wherein each of the plurality of SRS aggregates is associated with a cell identifier from a wireless communication node. The wireless communication device can transmit an SRS according to at least one of the SRS aggregates to the wireless communication node.

### CROSS-REFERENCE TO RELATED APPLICATION

This application claims the benefit of priority under 35 U.S.C. § 120 as a continuation of PCT Patent Application No. PCT/CN2022/070926, filed on Jan. 10, 2022, the disclosure of which is incorporated herein by reference in its entirety.

### TECHNICAL FIELD

The disclosure relates generally to wireless communications, including but not limited to systems and methods for communicating reference signals for positioning.

### BACKGROUND

A location server is a physical or logical entity that can collect measurements and other location information from the device and base station, and can utilize the measurements and estimate characteristics such as its position. The location server can process a request from the device and can provide the device with the requested information.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device can receive a first message indicating a plurality of Sounding Reference Signal (SRS) aggregates from a wireless communication node. Each of the plurality of SRS aggregates can be associated with a cell identifier. The wireless communication device can transmit an SRS according to at least one of the SRS aggregates to the wireless communication node.

In some implementations, the SRS aggregates may each include one of: an SRS configuration, an SRS resource set, or an SRS resource. In some cases, the first message can further indicate a cell list containing the cell identifiers of the plurality of SRS aggregates. In some implementations, the cell identifiers can be associated with a plurality of cells, respectively, in a Radio Access Network (RAN)-based Notification Area (RNA).

In some implementations, the wireless communication device can report a maximum number of the plurality of SRS aggregates that the wireless communication device can support to the wireless communication node. In some implementations, the cell identifier can include at least one of a Physical Cell Identifier (PCI) or an NCGI (New Radio (NR) Cell Global Identifier). In some cases, the wireless communication device can receive a second message indicating the wireless communication device to enter to RRC_CONNECTED state, while receiving no further SRS aggregate, from the wireless communication node.

In some implementations, the wireless communication device can determine to continue sending the SRS to the wireless communication node according to one of the SRS aggregates that the wireless communication device applied in a latest RRC_CONNECTED state. In some cases, the wireless communication device can determine to continue sending the SRS to the wireless communication node according to one of the SRS aggregates that the wireless communication device applied in a latest RRC_INACTIVE state or RRC_IDLE state.

In some implementations, the wireless communication device can determine not to send the SRS to the wireless communication node. In some implementations, the wireless communication device can receive a third message indicating whether the wireless communication device is to send the SRS to the wireless communication node during an upcoming RRC_INACTIVE period or RRC_IDLE period from the wireless communication node. In some cases, the third message may be included in a paging Downlink Control Information (DCI).

In some implementations, the third message may be included a Radio Resource Control Release (RRCRelease) message with suspension configuration. In some cases, the third message is included in Small Data Transmission (SDT) Downlink (DL) Radio Resource Control (RRC) message. In some implementations, the wireless communication device can receive the plurality of SRS aggregates of one or more NG-RAN nodes from the wireless communication node, where the wireless communication node receives the plurality of SRS aggregates from a wireless communication element. In some implementations, the one or more NG-RAN nodes can be within an RNA or a pre-configured NG-RAN node list.

At least one aspect is directed to a system, method, apparatus, or a computer-readable medium. A wireless communication node can transmit a first message indicating a plurality of Sounding Reference Signal (SRS) aggregates, wherein each of the plurality of SRS aggregates is associated with a cell identifier to a wireless communication device. The wireless communication node can receive an SRS according to at least one of the SRS aggregates from the wireless communication device.

In some implementations, the wireless communication node can receive the SRS aggregates that are configured by the wireless communication element based on a respective SRS aggregate of each of one or more NG-RAN nodes from a wireless communication element. In some cases, the one or more NG-RAN nodes can be within an RNA or a pre-configured NG-RAN node list.

At least one aspect is directed to a system, method, apparatus, or a computer-readable medium. A wireless communication device can receive a first message indicating a plurality of Positioning Reference Signal (PRS) configurations, wherein each of the plurality of PRS configurations is associated with an identifier from a wireless communication element. The wireless communication device can send an on-demand PRS request selecting one or more of the plurality of PRS configurations to the wireless communication element.

In some implementations, the on-demand PRS request can include the respective identifier of each of the plurality of PRS configurations. In some cases, each of the plurality of PRS configurations may include a plurality of elements, each of the plurality of elements associated with a frequency layer. In some implementations, the wireless communication device can receive a second message indicating a plurality of additional PRS configurations, wherein each of the plurality of additional PRS configurations is associated with an identifier and includes one or more dynamically configurable PRS parameters from the wireless communication element.

In some implementations, the wireless communication device can receive a third message indicating a plurality of selected PRS index lists, wherein each of the plurality of selected PRS index lists is associated with a respective one of a plurality of positioning methods from the wireless communication element. In some cases, one of the selected PRS index lists can be one of the plurality of PRS configurations that is associated with a same positioning method.

In some implementations, a subset of one of the selected PRS index lists can be one of the plurality of PRS configurations that is associated with a same positioning method. In some implementations, the wireless communication device may expect to receive the first message in response to not receiving a third message indicating a plurality of selected PRS index lists from the wireless communication element.

In some implementations, the wireless communication device may expect not to receive the first message in response to receiving a third message indicating a plurality of selected PRS index lists from the wireless communication element. In some cases, the first message may be broadcasted by a wireless communication node.

The systems and methods presented herein include a novel approach for positioning the UE via reference signals communication. In certain aspects of the novel approach, the systems and methods can include user equipment (UE) (e.g., wireless communication device) configured with multiple sounding reference signal (SRS) aggregates. Each of the SRS aggregates can be associated with a cell identifier (ID). The SRS aggregate can include, correspond to, or refer to an SRS configuration, SRS resource set, or SRS resource. In some implementations, under certain conditions, the UE can be configured with a default/standard/unmodified behavior for transmitting SRS. For instance, the condition can include the base station (e.g., gNB or wireless communication node) indicating/instructing the UE to enter/initiate RRC_CONNECTED state/mode/operation without sending new SRS configuration to the UE. In some cases, the default behavior (e.g., a first default behavior) can include continuing to transmit SRS following/based on/according to the last SRS configuration in RRC_CONNECTED. In some other cases, the default behavior can include continuing to transmit SRS following the last/most recent or previous SRS configuration in RRC_INACTIVE or RRC_IDLE. In certain cases, the default behavior can include stopping the transmission of the SRS.

In some implementations, the UE can receive an indication from the BS. The indication may indicate whether the UE should transmit the SRS during the upcoming RRC_INACTIVE or RRC_IDLE period. In some cases, indication may be embedded in paging DCI. In some other cases, the indication may be embedded in RRCRelease with suspend configuration.

In other aspects of the novel approach, the systems and methods can include a UE configured with an on-demand positioning reference signal (PRS) configuration. The on-demand PRS configuration can be determined according to or based on a selected PRS index list. In some cases, an available PRS configuration of each positioning method/procedure/operation may be or correspond to the selected PRS index list of each positioning method. In some cases, the available PRS configuration of each positioning method can correspond to a subset of selected PRS index list of each positioning method. In some other cases, if the UE receives the selected PRS index list (e.g., from the BS), the UE may not be expected to receive/obtain/collect available PRS configuration. In certain cases, if the UE receives an available PRS configuration, the UE may not be expected to receive the selected PRS index list. In some implementations, the UE can be configured to make an on-demand PRS request based on or responsive to broadcasting available PRS configuration.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example of sounding reference signal (SRS) configurations configured for the user equipment (UE), in accordance with some embodiments of the present disclosure;

FIG. 4 illustrates a flow diagram of an example method for positioning using SRS configuration, in accordance with an embodiment of the present disclosure; and

FIG. 5 illustrates a flow diagram of an example method for positioning using positioning reference signal (PRS) configuration, in accordance with an embodiment of the present disclosure.

### DETAILED DESCRIPTION

### 1. Mobile Communication Technology and Environment

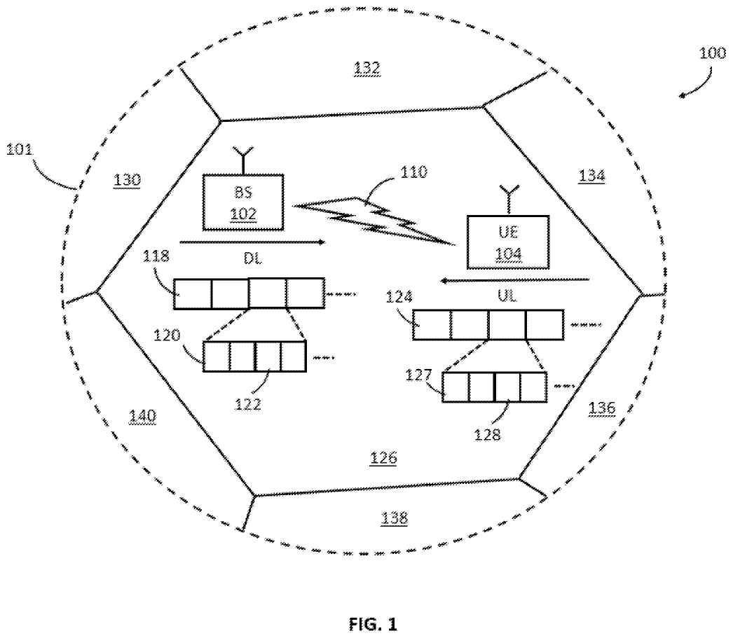

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

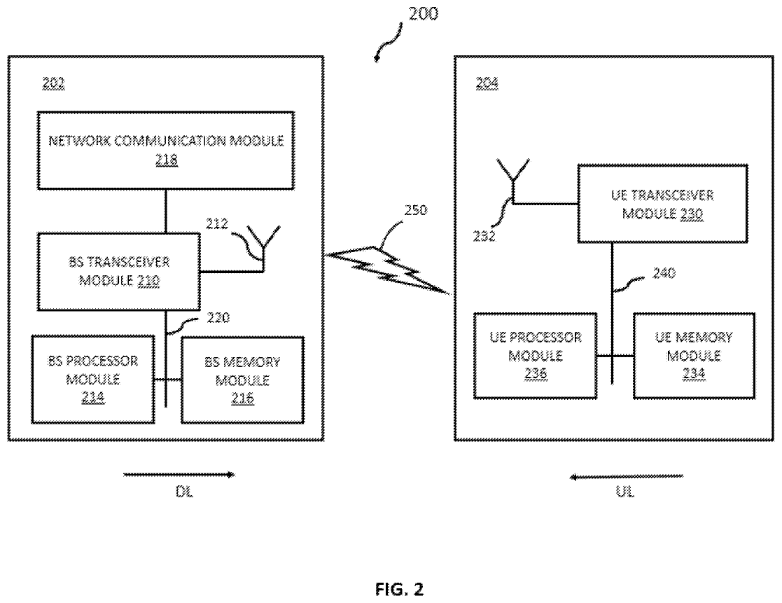

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Communicating Reference Signals for Positioning

In certain systems, the user equipment (e.g., UE 104 or wireless communication device) may be configured by the base station (e.g., BS 102, gNB, or wireless communication node). For example, the UE 104 may be configured to transmit a sounding reference signal (SRS) to the next generation radio access network (NG-RAN) node for uplink positioning. In an RRC_CONNECTED state, the SRS configuration can be configured per serving cell (e.g., one SRS configuration for a respective service cell, such as when different SRS resources suit/agree with/conform to different cells. For example, the SRS beam direction may be different when the UE 104 is in (e.g., positioned or located in) different cells. When the UE 104 performs cell handover, the UE 104 can be configured with a new/different SRS configuration for the new serving cell. However, when the UE 104 is in RRC_INACTIVE state and/or RRC_IDLE state, the UE 104 may perform/initiate/execute cell re-selection due to mobility of the UE 104. In certain systems, the network (e.g., one or more components or devices within the network 100) may not know which cell the UE 104 is in/belongs to/located. In such cases, since the network does not know the specific cell associated with the UE 104, the network may configure only one SRS configuration for one or more or all cells ahead of time or in advance. This single SRS configuration for all cells may not be suited/compatible/optimized for the mobility requirement of the UE 104 (e.g., among other UEs 104). Hence, the systems and methods described herein can provide SRS configuration in RRC_INACTIVE and/or RRC_IDLE to suit the SRS configuration for the UE 104.

In some other cases, certain systems may include a UE 104 configured with available PRS configuration, such that the UE 104 can initiate/make an on-demand PRS request (e.g., request for PRS). The systems and methods of the technical solution discussed herein can include/provide detailed configuration of available PRS configuration and address/resolve the conflict of location management function (LMF) (e.g., wireless communication element) providing available PRS configuration and LMF providing available PRSs per positioning method.

The systems and methods of the technical solution discussed herein can include at least a UE 104, a LMF, and a node (e.g., an NG-RAN node or BS 102), among other devices, systems, and/or components of network 100 or system 200 described in conjunction with FIGS. 1-2. The one or more components (e.g., UE 104, LMF, and/or node) can be involved/utilized/leveraged to achieve/complete/attain a positioning procedure or process. In certain systems, a positioning procedure may include, for instance, three steps. In a first step, the LMF can transmit a request to the UE 104 for its capability on positioning (e.g., requests for UE capability). In response to receiving the request, the UE 104 can report/send/respond/provide the UE capability to the LMF. In a second step, the UE 104 can request assistance data for positioning from the LMF. The LMF can gather/collect/aggregate all PRS information of the controlling BS 102 or transmission/reception point (TRP). Responsive to gathering the PRS information, the LMF can send UE assistance data to the UE 104 as a response. In a third step, LMF may send a request on positioning using a certain/specific positioning method. The UE 104 can start/begin to receive/obtain/measure PRS, make positioning measurements, and report/provide/send the measurement results and/or calculated UE position estimate, such as to the LMF or the BS 102. The UE 104 may start to transmit or initiate transmission of SRS for uplink (UL) positioning.

As discussed herein, a mobile originated location request (MO-LR) can refer to a request sent/provided/transmitted by the UE 104 to a serving public land mobile network (PLMN) for location-related information for the UE 104. A mobile terminated location request (MT-LR) can refer to a location request sent by a location service (LCS) client and/or application function (AF) external or internal to a serving PLMN, such as sending to the PLMN (e.g., home PLMN (HPLMN) or visited PLMN (VPLMN)) for the location of a target UE 104. A network induced location request (NI-LR) can include, correspond to, or refer to a serving access and mobility management function (AMF) for a UE initiating the location of the UE 104 for certain regulatory service (e.g., an emergency call from the UE 104, etc.).

An LTE positioning protocol (LPP) session may be used/utilized/initiated/established between a location server and the target device (e.g., the UE 104), for instance, to obtain location-related measurements and/or a location estimate, and/or to transfer assistance data. An LPP session (e.g., a single session) may be used to support a location request (e.g., a single location request for a single MT-LR, MO-LR or NI-LR). Multiple LPP sessions can be used between the same endpoints to support multiple different location requests. The multiple LPP sessions may not have a timing relationship (e.g., the timings between multiple TPP sessions can be sequential or overlapping).

Assistance data can include/contain information for the UE 104 to perform positioning and/or calculate/estimate/compute/determine its location, such as TRP list and their location, PRS information, etc. In some cases, the BS 102 can broadcast/signal/transmit the assistance data, such as to one or more UEs 104. The UE 104 can receive/obtain/acquire the assistance data from the BS 102 via dedicated signaling (e.g., LPP signaling in the non-access stratum (NAS) message).

The systems and methods discussed herein can include a target device, which can be the UE 104. The location server may include, correspond to, or refer to the LMF. The NG-RAN node can correspond to, include, or be referred to as the BS 102 (e.g., gNB), ng-eNB, TRP, PRS-only TP, or SRS-only RP. In some cases, the NG-RAN node may correspond to a gNB or an ng-eNB that controls one or more TRPs, PRS-only TP, or SRS-only TP. The BS 102, UE 104, and/or the LMF can perform one or more features, functionalities, operations, procedures, or methods discussed herein, such as one or more implementations herein, for positioning of the UE 104.

I Implementation 1: UE Configured with Multiple SRS Configurations with Different Cell Identifiers in a List of Cells

In some implementations, the UE 104 may be configured with multiple SRS configurations with different cell identifiers (IDs) in a list of cells. For example, prior to/before the UE 104 transmit SRS to the network (NW) or BS 102, the UE 104 can be configured with at least one SRS configuration. In some cases, the NW may refer to the BS 102. The UE 104 can be configured with multiple SRS configurations in one DL transmission to the UE 104. The multiple SRS configurations can be used by the UE 104, such as to transmit SRS in different physical cells.

In some cases, the UE 104 can be configured with a cell list or one or more cells. The cell list can include/contain one or more cell IDs. The cells may be contained in a radio access network (RAN)-based notification area (RNA), which can be reused as the cell list. Each cell ID in the cell list may correspond to or be associated with a respective SRS configuration. In some cases, different cell IDs may correspond to the same or similar SRS configuration (e.g., multiple cell IDs may identify/represent one SRS configuration). For example, each SRS configuration can include a field indicating the corresponding physical cell ID (PCI). If the UE 104 relocates/moves/repositions/traverses into at least one of the cells in the configured cell list, the UE 104 can transmit periodic SRS following/based on/according to the corresponding SRS configuration in response to/after/subsequent to the UE 104 acquiring/obtaining/receiving the cell ID associated with the respective cell. For semi-persistent SRS, the UE 104 can be triggered (e.g., by the BS 102) to transmit a corresponding SRS based on the corresponding SRS configuration.

In some implementations, the UE 104 can be configured with multiple SRS resource sets in one DL transmission. The multiple SRS resource sets may be used for or by the UE 104 to transmit SRS in different physical cells. The UE 104 can be configured with a cell list, which can include/contain one or more cell IDs. In some cases, the UE 104 can be configured with RNA (e.g., reused as the cell list). Each cell ID in the cell list may correspond to one or more SRS resource sets. In some cases, different cell IDs can correspond to the same SRS resource set. The association relationship (e.g., between the cell ID and the SRS resource set) can be configured in the corresponding or respective SRS resource set. For example, each SRS resource set may include a field indicating a corresponding PCI. In this example, if the UE moves/transitions/reposition into one of the cells in the configured cell list, after/subsequent to the UE 104 acquiring/obtaining/receiving the cell ID, the UE 104 can transmit periodic SRS to the BS 102 following or according to the corresponding SRS resource set configuration. For semi-persistent SRS, the UE 104 may be triggered, such as by the BS 102, to transmit corresponding SRS following the corresponding SRS resource set configuration. In certain other aspects, different cell IDs may correspond to different SRS resource sets. The different SRS resource sets may include one or more similar and/or different features or configurations between each other.

The cell ID may correspond to a physical cell identifier (PCI) and/or NCGI (NR cell global identifier). The multiple SRS configurations/SRS resource sets/SRS resources with different cell IDs can be configured in different states of the UE 104, such as RRC_CONNECTED, RRC_INACTIVE, and/or RRC_IDLE. The maximum/total number of the multiple SRS configurations/SRS resource sets/SRS resources associated with the cell IDs may be predetermined/preconfigured/predefined. The maximum number of multiple SRS configurations/SRS resource sets/SRS resources associated with the cell IDs can be an integer. In some cases, the maximum number of the multiple SRS configurations/SRS resource sets/SRS resources associated with cell IDs can include, correspond to, or be a part of a UE capability (e.g., hardware and/or software performance, support, etc.) reporting.

The SRS configurations/SRS resource sets/SRS resources can be configured by a serving BS 102 (e.g., gNB or node). The BS 102 can transmit/send/provide the SRS configurations/SRS resource sets/SRS resources to the UE 104. The serving BS 102 may request neighboring/adjacent/nearby BS 102 to transmit at least one SRS configuration of each neighbor BS in advance or prior to transmitting the SRS configurations to the UE 104. The serving BS 102 and/or the neighboring BS can be within an RNA. The SRS configurations/SRS resource sets/SRS resources can be applied/implemented/utilized by the UE 104, such as when a timing advance (TA) is not expired. In some cases, the SRS configurations/SRS resource sets/SRS resources can be applied by the UE 104 when the UE is not sending RRC resume/continue requests, such as when the UE 104 is within RNA.

II. Implementation 2: Multiple SRS Configurations come from Serving BS with Assistance of LMF

In some implementations, the one or more SRS configurations can be received or come from the serving BS 102, such as with the help/assistance of or facilitated by the LMF. The SRS configurations/SRS resource sets/SRS resources can be from the serving BS 102. For example, the LMF can gather/collect/obtain multiple SRS configurations of the BS 102. Responsive to receiving the SRS configurations, the LMF can send/transmit/provide the SRS configurations with cell identifiers to the BS 102. Subsequently, the serving BS 102 may send the multiple SRS configurations with cell identifiers to the UE 104 for positioning in RRC_INACTIVE state and/or RRC_IDLE state. For instance, the LMF can send a positioning information request to one or more NG-RAN nodes (e.g., multiple NG-RAN nodes) for SRS configuration (e.g., of the respective node) or request ‘Requested SRS Transmission Characteristics’. Each NG-RAN node may correspond to one of the BSs. The one or more NG-RAN nodes can reply/respond with a response to the positioning information request (e.g., LMF positioning information response). The positioning information response may include the SRS configuration with cell identifiers of each NG-RAN node. Responsive to receiving the response from the NG-RAN node, the LMF can send the serving BS 102 (e.g., BS 102 serving the UE 104) the multiple SRS configurations with cell identifiers of the one or more NG-RAN nodes. The one or more NG-RAN nodes can be within an RNA or a pre-configured NG-RAN node list. Accordingly, the serving BS 102 can provide/send the multiple SRS configurations with cell identifiers to the UE 104. The UE 104 can receive the SRS configurations associated with each respective NG_RAN node, such as to let perform UL/DL and/plus UL positioning (e.g., UL-TDOA or multi-RTT) in RRC_INACTIVE state or RRC_IDLE state.

In some cases, when the NG-RAN sends a response to the LMF, multiple NG-RAN nodes may reply to the LMF with the positioning information response including the SRS configuration of each cell within the NG-RAN node. Each NG-RAN node may correspond to one or more cells. For instance, each NG-RAN node can reply/respond to the LMF with SRS configurations including PCIs or NR cell global identifiers (NCGIs). In some cases, each NG-RAN node can reply with multiple SRS configurations corresponding to multiple cells with cell identifiers of the NG-RAN node. In this case, individual SRS configurations can be associated with a PCI or NCGI.

In some other cases, when the NG-RAN sends a response to the LMF, multiple NG-RAN nodes may reply to the LMF with the positioning information response including the SRS resources/SRS resource sets of each cell with cell identifiers within the NG-RAN node. For example, each NG-RAN node can reply to the LMF with SRS resource sets/SRS resources with PCIs or NCGIs. Each NG-RAN node can reply with multiple SRS resources/SRS resource sets corresponding to multiple cells of the NG-RAN node.

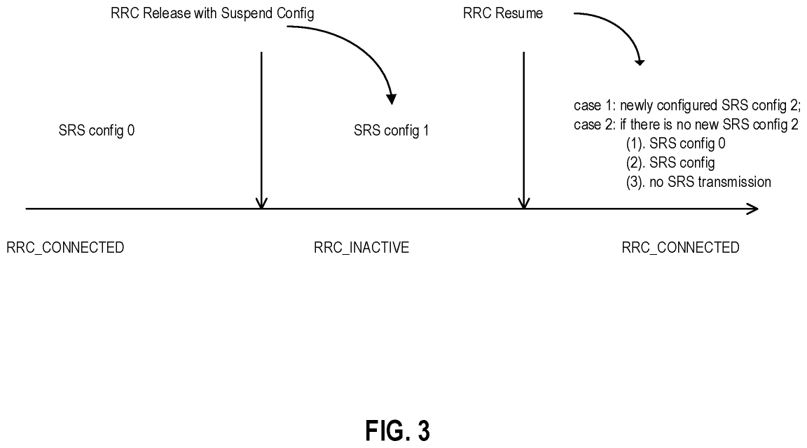

Referring to FIG. 3, depicted is an example of SRS configurations configured for the UE 104. The states of the UE 104 can include at least RRC_CONNECTED and RRC_INACTIVE/RRC_IDLE. In the RRC_INACTIVE/RRC_IDLE state, the default behavior of the UE 104 on the last SRS configuration in RRC_CONNECTED, the last SRS configuration in RRC_INACTIVE, and/or without SRS can be shown in FIG. 3. In RRC_CONNECTED, the UE 104 can receive SRS configuration from the BS 102 to transmit SRS in RRC_CONNECTED. The UE 104 may receive the SRS configuration used for the UE 104 to transmit SRS in RRC_INACTIVE or RRC_IDLE state. The RRC_INACTIVE may correspond to or refer to the RRC_IDLE state. The SRS in RRC_CONNECTED and SRS in RRC_INACTIVE/IDLE may be different or not the same.

Responsive to receiving the SRS configuration, the UE 104 can send an RRC resume request for connection to the BS 102. Subsequently or after receiving the RRC resume request, the BS 102 may transmit/convert/instruct/modify/configure the UE 104 to RRC_CONNECTED state via RRCResume message. The RRCResume message can be included/provided with a new SRS configuration.

If the BS 102 indicates to the UE 104 to enter RRC_CONNECTED and the BS 102 does not send a new SRS configuration to UE 104, the UE 104 may be indicated with default behavior. The default behavior can indicate how the UE 104 transmits SRS to the BS 102. For example, the default behavior may include at least one of: 1) continue transmitting SRS following or according to the last/most recent/previous SRS configuration (e.g., SRS config 0 or a first SRS configuration) in RRC_CONNECTED, 2) continue transmitting SRS following the last SRS configuration (e.g., SRS config 1 or a second SRS configuration) in RRC_INACTIVE/RRC_IDLE, and/or 3) stop transmitting SRS (e.g., no SRS transmission), among other behaviors.

In some cases, if the UE 104 is configured with SRS configuration in RRC_INACTIVE/RRC_IDLE (e.g., in RRCRelease with suspend configuration), the UE 104 can transmit (e.g., be expected to transmit) the SRS following the SRS configuration only in RRC_INACTIVE/RRC_IDLE. When the UE 104 enters RRC_CONNECTED state, the UE 104 may be configured/provided with a new SRS configuration (e.g., by the BS 102), or follow a legacy SRS configuration configured in the last RRC_CONNECTED state. The UE 104 may not adopt/implement/utilize the SRS configuration in RRC_INACTIVE/RRC_IDLE in RRC_CONNECTED. For example, as shown in FIG. 3, the SRS configuration can be configured for the UE 104 to transmit SRS in RRC_INACTIVE state. Upon the UE 104 entering or changing to the RRC_CONNECTED state, the UE 104 may not use the SRS config 1 in subsequent SRS transmission. For instance, the second case (e.g., case 2) may not be adopted by the UE 104 subsequent to the RRC resume, e.g., after/subsequent to the UE 104 entering the RRC_CONNECTED state.

III. Implementation 3: Network Notify the UE whether to Transmit SRS in Paging

In some implementations, in RRC_INACTIVE/IDLE, the BS 102 or NW can indicate to the UE 104 whether to transmit/send SRS in paging DCI or in RRC_release with suspending configuration. For example, the UE 104 can be allowed/configured to use SRS configuration in RRC_CONNECTED as SRS configuration for RRC_INACTIVE/RRC_IDLE, SRS configuration in RRCRelease with suspend configuration for RRC_INACTIVE/RRC_IDLE, and/or SRS configuration in SDT DL RRC message (e.g., Message B/Message 4 of RA-SDT) for RRC_INACTIVE/RRC_IDLE. Random access small data transmission (RA-SDT) can include/involve the UE 104 initiating random access procedure requesting SDT resource. Message B or message 4 of RA-SDT can correspond to the response/reply from the BS 102 responsive to the UE's 104 initial random access. The SRS configuration can be embedded in the BS's 102 response message, e.g., Message B/Message 4 of RA-SDT for RRC_INACTIVE/RRC_IDLE. When receiving the SRS configuration for RRC_INACTIVE, the UE 104 can expect to receive an indication from the NW of whether the UE 104 should transmit the SRS during the upcoming/subsequent/next RRC_INACTIVE/RRC_IDLE period. The SRS can be a periodic SRS or semi-persistent SRS. The indication received by the UE 104 can be embedded/included in at least one of a paging DCI, RRCRelease with suspend configuration, and/or SDT DL RRC message.

For example, for paging DCI, the NW can send the paging DCI to page the UE 104 in RRC_INACTIVE/RRC_IDLE state. When one or more UEs 104 with the same UE ID receives the paging DCI, the one or more UEs 104 can receive an indication on whether to transmit SRS in the upcoming RRC_INACTIVE state. For example, the indication can correspond to one bit. The one bit can be contained/included/embedded/implemented in a short message indicator in the DCI format 1_0 with CRC scrambled by P-RNTI, in which the bit field ′00′ can be used. In another example, the indicator can be contained in multiple/various short messages in the DCI format 1_0 with CRC scrambled by P-RNTI. In further example, the indicator can be contained in a reserved bits field in the DCI format 1_0 with CRC scrambled by P-RNTI. If the UE 104 receives the bit value of 1, the bit can denote/indicate in the upcoming/subsequent RRC_INACTIVE or RRC_IDLE for the UE 104 to transmit SRS following the SRS configuration in RRC_INACTIVE/RRC_IDLE.

For the RRCRelease with suspend configuration, the NW can send the RRCRelease with suspend configuration (e.g., SuspendConfig) to the UE 104. The RRCRelease with SuspendConfig can be used by or indicate to the UE 104 to enter or maintain in the RRC_INACTIVE state. The one bit indicator can be configured in the SuspendConfig or the SRS configuration configured in SuspendConfig.

### 1V. Implementation 4: Available PRS Configurations—Add New IE in NR-DL-PRS Assistance Data

In some implementations, for available PRS configurations, a new IE can be added to the NR-DL-PRS assistance data, such as at least an identifier (ID) associated for a respective UE 104. For example, if the UE 104 receives NR-DL-PRS-AssistanceData via broadcasting by the BS 102 (e.g., the serving BS 102) or NW, or via LPP signaling in the NAS message, the UE 104 may receive several/multiple sets in NR-DL-PRS-AssistanceData. Each of the sets may include/contain one or more elements. Each element of a set can contain assistance data configured for a certain frequency layer. Each set can be associated with an ID for the UE 104 to make/initiate/transmit/execute an on-demand PRS request. The maximum/total/highest number of the sets can be determined by the NW, or by the UE capability reporting. For instance, the NW can determine the number of the sets based on the capability (e.g., hardware and/or software performance, support, capability, etc.).

The several sets can be seen as an available PRS configuration that the LMF provided/transmitted to UE. For example, for broadcast signaling, the available PRS configuration can be embedded/included/configured/established in NR-DL-PRS-AssistanceData. In another example, for dedicated LPP signaling, the available PRS configuration can be embedded in ProvideAssistanceData, such as NR-DL-TDOA-ProvideAssistanceData-rl6, NR-Multi-RTT-ProvideAssistanceData-r16, or NR-DL-AoD-ProvideAssistanceData-r16. In some cases, one or more information of the ProvideAssitanceData can include, correspond to, or be a part of the NR-DL-PRS-AssistanceData. In certain cases, the multiple sets may be presented, and if the field (e.g., on-demand PRS request field) is absent, the UE 104 may discontinue, stop using, or delete one or more existing values and/or the associated functionality. The term ‘delete’ may correspond to the need code ‘need OR’, such as indicated in the specification. For instance, the UE 104 may discontinue/stop using/delete any existing value and/or the associated functionality by removing the buffered information out of or from the UE memory.

The UE 104 can request on-demand PRS from a range of available PRS configurations. The UE 104 can request the IDs of or associated with the different sets as a part of the on-demand PRS request in NR-DL-TDOA-RequestAssistanceData, NR-Multi-RTT-RequestAssistanceData-r16, and/or NR-DL-AoD-RequestAssistanceData-r16. In some cases, if the on-demand PRS request field is absent, the UE 104 can discontinue, stop using, or delete any existing value and/or the associated functionality. In some other cases, the field can be present/not absent/occupied/exist, such as if the UE 104 receives the one or more set(s).

For example, the ASN.1 description/information/details of NR-DL-PRS-AssistanceData and NR-DL-TDOA-RequestAssistanceData can be modified/configured/adjusted as follows. The UE 104 can request on-demand PRS per positioning method/procedure/operation, such that the UE on-demand PRS request may be embedded in NR-Multi-RTT-RequestAssistanceData-r16 and/or NR-DL-AoD-RequestAssistanceData-rl6.

### For NR-DL-PRS-AssistanceData

-- ASN1START
NR-DL-PRS-AssistanceData-r16 ::= SEQUENCE {

| | |
|---|---|
| nr-DL-PRS-ReferenceInfo-r16 | DL-PRS-ID-Info-r16, |

nr-DL-PRS-AssistanceDataListSet-r17 ::= SEQUENCE {

| | |
|---|---|
| nr-DL-PRS-AssistanceDataListSetID-r17 | NR-DL-PRS-AssistanceDataListSetID-r17 |

OPTIONAL

| | |
|---|---|
| NR-DL-PRS-AssistanceDataListSet-r17 | (SIZE (1..nrMaxAssistanceDataList-r17)) OF nr-DL- |
| PRS-AssistanceDataList-r16 | OPTIONAL |

}
nr-DL-PRS-AssistanceDataList-r16SEQUENCE (SIZE (1..nrMaxFreqLayers-r16)) OF

NR-DL-PRS-AssistanceDataPerFreq-r16,

```
nr-SSB-Config-r16 SEQUENCE (SIZE (1..nrMaxTRPs-r16)) OF NR-SSB-Config-r16
OPTIONAL, -- Need ON
  ...
}
NR-DL-PRS-AssistanceDataPerFreq-r16 ::= SEQUENCE {
  nr-DL-PRS-PositioningFrequencyLayer-r16
```

NR-DL-PRS-PositioningFrequencyLayer-r16,

nr-DL-PRS-AssistanceDataPerFreq-r16 SEQUENCE (SIZE (1..nrMaxTRPsPerFreq-r16)) OF

NR-DL-PRS-AssistanceDataPerTRP-r16,

...
}
NR-DL-PRS-AssistanceDataPerTRP-r16 ::= SEQUENCE {

| dl-PRS-ID-r16 | INTEGER (0..255), | |
|---|---|---|
| nr-PhysCellID-r16 | NR-PhysCellID-r16 | OPTIONAL, -- Need ON |
| nr-CellGlobalID-r16 | NCGI-r15 | OPTIONAL, -- Need ON |
| nr-ARFCN-r16 | ARFCN-ValueNR-r15 | OPTIONAL, -- Cond |

NotSameAsRefServ

| | |
|---|---|
| nr-DL-PRS-SFN0-Offset-r16 | NR-DL-PRS-SFN0-Offset-r16, |
| nr-DL-PRS-ExpectedRSTD-r16 | INTEGER (−3841..3841), |

nr-DL-PRS-ExpectedRSTD-Uncertainty-r16

| | |
|---|---|
| | INTEGER (0..246), |
| nr-DL-PRS-Info-r16 | NR-DL-PRS-Info-r16, |

```
  ...
}
NR-DL-PRS-PositioningFrequencyLayer-r16 ::= SEQUENCE {
  dl-PRS-SubcarrierSpacing-r16 ENUMERATED {kHz15, kHz30, kHz60, kHz120, ...},
```

| | |
|---|---|
| dl-PRS-ResourceBandwidth-r16 | INTEGER (1..63), |
| dl-PRS-StartPRB-r16 | INTEGER (0..2176), |
| dl-PRS-PointA-r16 | ARFCN-ValueNR-r15, |
| dl-PRS-CombSizeN-r16 | ENUMERATED {n2, n4, n6, n12, ...}, |
| dl-PRS-CyclicPrefix-r16 | ENUMERATED {normal, extended, ...}, |

...
}
NR-DL-PRS-SFN0-Offset-r16 ::= SEQUENCE {

| | |
|---|---|
| sfn-Offset-r16 | INTEGER (0..1023), |
| integerSubframeOffset-r16 | INTEGER (0..9), |

...}
-- ASN1STOP

ProvideAssistanceData field descriptions
NR-DL-PRS-AssistanceDataListSet
Identify the set of NR-DL-PRS-Assistance DataList.
NR-DL-PRS-AssistanceDataListSetID
Identify the ID of NR-DL-PRS-AssistanceDataListSet.

### For NR-DL-PRS-AssistanceDataListSetID

-- ASN1START
NR-DL-PRS-AssistanceDataListSetID-r17 ::= INTEGER (0..nrMaxAssistanceDataListSet-r17-1)
-- ASN1STOP
--NR-DL-TDOA-RequestAssistanceData
-- ASN1START
NR-DL-TDOA-RequestAssistanceData-r16 ::= SEQUENCE {

| nr-PhysCellID-r16 | NR-PhysCellID-r16 | OPTIONAL, |
|---|---|---|
| nr-AdType-r16 | BIT STRING { dl-prs (0), | |
| | posCalc (1) } (SIZE (1..8)), | |
| OnDemandPrsRequest-r17 | NR-DL-PRS-AssistanceDataListSetID-r17 | optional, need OR |

...
}
-- ASN1STOP

Provide AssistanceData field descriptions
OnDemandPrsRequest
Identify the on-demand PRS request of a target device.
NR-DL-PRS-AssistanceDataListSetID
Identify the ID of NR-DL-PRS-AssistanceDataListSet.

In certain cases, the UE 104 may associate/link/conform the on-demand PRS request with the NR-DL-PRS-AssistanceData. For example, the available PRS configuration can correspond to the NR-DL-PRS-AssistanceData. The UE 104 can make/trigger an on-demand PRS request within the range of NR-DL-PRS-AssistanceData.

V. Implementation 5: Available PRS configurations—Add New IEs in NR-DL-PRS-AssistanceData

In some implementations, for available PRS configurations, multiple new IEs can be added in the NR-DL-PRS-AssitanceData, such as one or more explicit parameters (e.g., PRS parameters). For example, the LMF can configure sets of on-demand PRS in NR-DL-PRS-AssistanceData-r16. Each of the sets can include a respective ID. Each set may include/contain certain PRS parameters that can be dynamically requested. For instance, the PRS parameters can include one or more of at least DL PRS periodicity, DL PRS resource bandwidth, DL PRS Quasi-Colocation (QCL) information, start/end time of DL PRS transmission, DL PRS resource repetition factor, a number of DL PRS resource symbols per DL PRS resource, DL-PRS CombSizeN, a number of DL PRS frequency layers, and/or ON/OFF indicator, among others. In some cases, the sets may or may not be presented.

When requesting the on-demand PRS, the UE 104 may request the ID of the one or more sets. For example, the ASN.1 description of NR-DL-PRS-AssistanceData and NR-DL-TDOA-RequestAssistanceData may be modified/configured as follows. The UE 104 can request on-demand PRS per positioning method, such that the UE on-demand PRS can be embedded in NR-Multi-RTT-RequestAssistanceData-r16 and/or NR-DL-AoD-RequestAssistanceData-rl6.

### For NR-DL-PRS-AssistanceData

-- ASN1START
NR-DL-PRS-AssistanceData-r16 ::= SEQUENCE {

| | |
|---|---|
| nr-DL-PRS-ReferenceInfo-r16 | DL-PRS-ID-r16, |

nr-DL-PRS-AssistanceDataList-r16SEQUENCE (SIZE (1..nrMaxFreqLayers-16)) OF

| | |
|---|---|
| | NR-DL-PRS-AssistanceDataPerFreq-r16, |
| nr-DL-PRS-OnDemandAssistanceDataList-r17 | SEQUENCE (SIZE |

```
(1..nrMaxOnDemandAssistanceData-r17)) OF NR-DL-PRS-OnDemandAssistanceData-r17
OPTIONAL Need ON
nr-SSB-Config-r16 SEQUENCE (SIZE (1..nrMaxTRPs-r16)) OF NR-SSB-Config-r16
OPTIONAL, --Need On
  ...
}
NR-DL-PRS-AssistanceDataPerFreq-r16 ::= SEQUENCE {
  nr-DL-PRS-PositioningFrequencyLayer-r16
```

NR-DL-PRS-PositioningFrequencyLayer-r16,

nr-DL-PRS-AssistanceDataPerFreq-r16 SEQUENCE (SIZE (1..nrMaxFreqLayers-16)) OF

NR-DL-PRS-AssistanceDataPerTRP-r16,

...
}
NR-DL-PRS-AssistanceDataPerTRP-r16 ::= SEQUENCE {

| dl-PRS-ID-r16 | INTEGER (0..255), | |
|---|---|---|
| nr-PhysCellID-r16 | NR-PhysCellID-r16 | OPTIONAL, -- Need ON |
| nr-CellGlobalID-r16 | NCGI-r15 | OPTIONAL, -- Need ON |
| nr-ARFCN-r16 | ARFCN-ValueNR-r15 | OPTIONAL, -- Cond |

NotSameAsRefServ

| | |
|---|---|
| nr-DL-PRS-SFN0-Offset-r16 | NR-DL-PRS-SFN0-Offset-r16, |
| nr-DL-PRS-ExpectedRSTD-r16 | INTEGER (−3841..3841), |

nr-DL-PRS-ExpectedRSTD-Uncertainty-r16

| | |
|---|---|
| | INTEGER (0..246), |
| nr-DL-PRS-Info-r16 | NR-DL-PRS-Info-r16, |

```
  ...
}
NR-DL-PRS-PositioningFrequencyLayer-r16 ::= SEQUENCE {
  dl-PRS-SubcarrierSpacing-r16 ENUMERATED {kHz15, kHz30, kHz60, kHz120, ...},
```

| | |
|---|---|
| dl-PRS-ResourceBandwidth-r16 | INTEGER (1..63), |
| dl-PRS-StartPRB-r16 | INTEGER (0..2176), |
| dl-PRS-PointA-r16 | ARFCN-ValueNR-r15, |
| dl-PRS-CombSizeN-r16 | ENUMERATED {n2, n4, n6, n12, ...}, |
| dl-PRS-CyclicPrefix-r16 | ENUMERATED {normal, extended, ...}, |

...
}
NR-DL-PRS-OnDemandAssistanceData-r17 ::= SEQUENCE {
nr-DL-PRS-OnDemandAssistanceDataID-r17 INTEGER(0..nrMaxOnDemandAssistanceData-r17-1)

| | | |
|---|---|---|
| PrsStartTime-r17 | UTCTime | OPTIONAL |
| PrsEndTime-r17 | UTCTime | OPTIONAL |

dl-PRS-ResourceRepetitionFactor-r16 ENUMERATED {n2, n4, n6, n8, n16, n32, ...}
OPTIONAL,

| dl-PRS-NumSymbols-r16 | ENUMERATED {n2, n4, n6, n12, ...}, OPTIONAL, | |
|---|---|---|
| dl-PRS-CombSizeN-r16 | ENUMERATED {n2, n4, n6, n12, ...}, OPTIONAL, | |
| dl-PRS-ResourceBandwidth-r16 | INTEGER (1..63), | OPTIONAL, |
| NrFreqLayers | ENUMERATED {n1, n2, n3, n4}, | OPTIONAL, |

dl-PRS-Periodicity-and-ResourceSetSlotOffset-r16

| | NR-DL-PRS-Periodicity-and-ResourceSetSlotOffset-r16, OPTIONAL, | |
|---|---|---|
| dl-PRS-QCL-Info-r16 | DL-PRS-QCL-Info-r16 | OPTIONAL, |

...
}
NR-DL-PRS-SFN0-Offset-r16 ::= SEQUENCE {

| | |
|---|---|
| sfn-Offset-r16 | INTEGER (0..1023), |
| integerSubframeOffset-r16 | INTEGER (0..9), |

...}
-- ASN1STOP

Provide AssistanceData field descriptions
NR-DL-PRS-OnDemandAssistanceData
Identify the available PRS configuration for UE to
request on-demand PRS.
NR-DL-PRS-OnDemandAssistanceDataID
Identify the ID of NR-DL-PRS-OnDemandAssistanceData.

### For NR-DL-TDOA-RequestAssistanceData

-- ASN1START
NR-DL-TDOA-RequestAssistanceData-r16 ::= SEQUENCE {

| nr-PhysCellID-r16 | NR-PhysCellID-r16 | OPTIONAL, |
|---|---|---|
| nr-AdType-r16 | BIT STRING { dl-prs (0), | |
| | posCalc (1) } (SIZE (1..8)), | |
| OnDemandPrsRequest-r17 | NR-DL-PRS-OnDemandAssistanceDataID-r17 | OPTIONAL, |

need OR
...
}
-- ASN1STOP

VI. Implementation 6: UE Associates On-Demand PRS Request with Selected PRS Index List 1

In some implementations, the UE 104 can associate the on-demand PRS request with a selected PRS index list 1 (e.g., a first PRS index list). For example, if the available PRS configuration for the UE on-demand PRS request is embedded in nr-DL-PRS-AssistanceData-r16, the UE 104 can (or be configured to) feedback/respond with the on-demand PRS request based on or according to the available PRS configuration. The nr-SelectedDL-PRS-IndexList-r16 can be a selected PRS resource list configured in NR-DL-TDOA-ProvideAssistanceData-r16 (e.g., similarly for NR-DL-AoD-ProvideAssistanceData-r16 and/or NR-Multi-RTT-ProvideAssistanceData-r16). The PRS resources included/contained in the nr-SelectedDL-PRS-IndexList-r16 may be from nr-DL-PRS-AssistanceData-r16. The nr-DL-PRS-AssistanceData-r16 can indicate one or more PRS resources that are feasible/usable/viable in DL-TDOA, multi-RTT, or DL-AoD.

In some cases, the available PRS configuration may not be contained/included in nr-DL-PRS-AssistanceData-r16. In this case, the available PRS configuration can be a new IE parallel to or different from the nr-DL-PRS-AssistanceData-r16. In certain cases, if the PRS resources in the available PRS configuration are not the same as PRS resources in nr-SelectedDL-PRS-IndexList-r16, the UE 104 may request for PRS resources that are not suitable/optimized for the specific/respective positioning method. To avoid this case, the available PRS configuration can be configured/provided per positioning method. For instance, the UE 104 can associate the on-demand PRS request with the selected PRS index list provided/indicated/assigned for each positioning method.

For example, the available PRS configuration of each positioning method can be or correspond to the selected PRS index list of each positioning method. In this case, when the UE 104 make the on-demand PRS request, the UE 104 may choose (e.g., only choose) the PRS resources indicated in NR-SelectedDL-PRS-IndexList-r16. For instance, the UE 104 can request frequency layer index, TRP index, PRS resource set index, and/or PRS resource index in the range of the corresponding NR-SelectedDL-PRS-IndexList-r16.

In another example, the available PRS configuration of each positioning method may correspond to a subset of the selected PRS index list of each positioning method. In this case, the available PRS configuration can be a new IE. The new IE may contain/include certain frequency layer indexes, TRP indexes, PRS resource set indexes, and/or PRS resource indexes indicated/provided/presented in the nr-SelectedDL-PRS-IndexList-r16. The UE 104 can initiate the on-demand PRS request in the new IE, for example.

VII. Implementation 7: UE Associates On-Demand PRS Request with Selected PRS Index List 2

In some implementations, the UE 104 can associate the on-demand PRS request with a selected PRS index list 2 (e.g., a second PRS index list). For example, if the available PRS configuration for UE on-demand PRS request is embedded in nr-DL-PRS-AssistanceData-r16, the UE 104 may feedback/respond with the on-demand PRS request based on the available PRS configuration. In this case, the nr-SelectedDL-PRS-IndexList-r16 can be configured in NR-DL-TDOA-ProvideAssistanceData-r16, which may indicate one or more PRSs that are feasible in DL-TDOA. The nr-SelectedDL-PRS-IndexList-r16 may be chosen/selected/indicated by the LMF from nr-DL-PRS-AssistanceData-r16. In other cases, the available PRS configuration may not be contained in nr-DL-PRS-AssistanceData-r16. In this case, the available PRS configuration can be a new IE parallel to the nr-DL-PRS-AssistanceData-r16.

As in the aforementioned cases, the nr-SelectedDL-PRS-IndexList-r16 and available PRS configuration can be configured to the UE 104 at the same time or simultaneously. In some cases, the UE 104 may not be provided with information (e.g., may not know) on what the range of PRS the UE 104 should choose/select from (e.g., which PRSs can the UE 104 choose/select from), such as to receive or measure. To mitigate or avoid the conflict of configuring the nr-SelectedDL-PRS-IndexList-r16 and the available PRS configuration to the UE 104 at the same time, the UE 104 may not be expected to receive nr-SelectedDL-PRS-IndexList-r16 and available PRS configuration at the same time. For instance, the UE 104 can receive the nr-SelectedDL-PRS-IndexList-r16 and available PRS configuration at different times (e.g., timeframe, time period, moments, etc.).

The UE 104 may not receive the nr-SelectedDL-PRS-IndexList-r16 and available PRS configuration at the same time in various methods/operations/ways. For example, and in certain aspects, if the UE 104 receives the selected PRS index list, the UE 104 may not be expected to receive the available PRS configuration. In other aspects, if the UE 104 receives the available PRS configuration, the UE 104 may not be expected to receive the selected PRS index list. In further aspects, the UE 104 can only trigger/initiate/make the on-demand PRS request according to or based on the broadcasting available PRS configuration. In this case, the UE 104 may not be expected to receive the available PRS configuration in the dedicated LPP signaling. For instance, the available PRS configuration may exist only in the broadcasting assistance data sent from serving BS 102 to the UE 104.

### VIII. Implementation 8: Increase Available PRS Parameter Values Under Each Current PRS Parameter

In certain systems, the scope of available PRS configuration can be expected to be larger than the PRS configuration containing PRSs that the BS 102 will send/transmit. In some implementations, in or based on the NR-DL-PRS-AssistanceData, the UE 104 can be expected to receive one or more additional available PRS parameter values. For example, the UE 104 can receive an on-demand PRS resource bandwidth, where the IE may provide certain values for the UE 104 to choose/select. The on-demand PRS resource bandwidth can be configured with the same level of current/existing dl-PRS-ResourceBandwidth-r16 IE. One or more of the PRS parameters can be configured with the additional on-demand PRS parameter values.

The UE 104 can initiate the on-demand PRS request within the range of NR-DL-PRS-AssistanceData, including the PRS configuration (e.g., PRS configuration containing PRSs that BS 102 will send), and/or the available PRS configuration. The UE 104 can request one or more explicit PRS parameter values using or indicated in the UE on-demand PRS request.

### IX. Implementation 9: Configuration of UE-Specific Pre-Configured Assistance Data (AD) Identifier

In some implementations, the LMF can transmit/send/provide assistance data to provide PRS configuration (or other assistance information) to UE 104 for positioning. For example, in a specific LPP session, the LMF can send a message (e.g., assistance data) to the ProvideAssistanceData IE (e.g., a first ProvideAssistanceData IE). The message can be sent from the ProvideAssistanceData IE to the UE 104. The UE 104 can receive the message from the LMF and/or the ProvideAssistanceData IE. Responsive to receiving the message, the UE 104 can utilize/process the assistance data in certain steps/procedures/operations of the LPP session. For example, the UE 104 can receive and measure corresponding PRSs in the certain steps of the LPP session.

In another specific LPP session (e.g., a second LPP session), the LMF may send another ProvideAssistanceData IE (e.g., a second ProvideAssistanceData IE) containing different assistance data. In this case, the UE 104 can follow the ProvideAssistanceData in the second LPP session. In some implementations, different LPP sessions may share the same assistance data to reduce/minimize end-to-end positioning latency. The assistance data may include or be referred to as/called pre-configured assistance data (e.g., configured in advance of communication between the LMF and the UE 104).

The assistance data can be configured/premodified with an ID. For example, if the UE 104 receives the assistance data with the ID in a specific LPP session, the UE 104 may determine/decide that the assistance data can be used across multiple subsequent/latter LPP sessions. For instance, if the UE 104 receives the assistance data with the ID in one LPP session, the UE 104 can store/maintain/memorize the assistance data from the respective LPP session. Subsequently, the UE 104 can utilize the stored assistance data in the LPP session and one or more other LPP sessions, e.g., the UE 104 may receive and measure corresponding PRSs in the LPP session, among one or more other LPP sessions. Hence, the UE 104 may not be required/need to request or receive assistance data in the one or more other latter LPP sessions (e.g., receive and store the assistance data from the one LPP session). In another example, the UE 104 may receive the assistance data with an ID via a broadcast. The UE 104 can determine that the assistance data received via the broadcast can be used across multiple latter LPP sessions.

In some cases, if an ID is included/indicated/provided in the assistance data in a specific LPP session, the ID can be configured in one or more procedures. For example, the ID can be configured per ProvideAssistanceData IE. In this case, a flag can be added in ProvideAssistanceData and/or CommonProvideAssistanceData. The flag can identify/indicate/represent whether the assistance data in ProvideAssistanceData field is pre-configured. The flag may include an ‘OR’ statement/decision or a bit representing 1 or 0, true or false, etc. based on the flag value. If the flag value is true, the assistance data can be stored at the UE 104 and used in subsequent LPP sessions. If the flag is false or absent (e.g., flag is not included), this flag or lack of flag may denote that the assistance data is not pre-configured assistance data, no additional custom/special action is needed, and/or for the UE 104 to follow the legacy rule.

In another example, the ID can be configured per positioning method. In some cases, the a field can be added in the ProvideAssistanceData, including/containing information on whether assistance data of each positioning method is pre-configured assistance data. If the flag value of one or more positioning methods is true, the assistance data of the positioning method can be stored at the UE 104 and used in the latter LPP sessions. If the flag of one or more positioning method is false or absent, the flag may denote/indicate that the assistance data of the positioning method is not pre-configured assistance data, no additional action is needed, and/or for the UE 104 to follow the legacy rule.

In some other cases, a flag can be added in one or more of A-GNSS-ProvideAssistanceData, OTDOA-ProvideAssistanceData, EPDU-Sequence, Sensor-ProvideAssistanceData-r14, TBS-ProvideAssistanceData-r14, WLAN-ProvideAssistanceData-r14, NR-Multi-RTT-ProvideAssistanceData-r16, NR-DL-AoD-ProvideAssistanceData-r16, and/or NR-DL-TDOA-ProvideAssistanceData-r16. If the flag value of the corresponding positioning method is true, the assistance data of this positioning method should be stored at UE and used in the latter LPP sessions. If the flag of the corresponding positioning method is false or absent, the flag may denote that the assistance data of the positioning method is not pre-configured assistance data, no additional special action is needed, and for the UE 104 to follow the legacy rule. In some implementations, the ID may be presented or may not be presented. If the field is absent, the UE 104 may discontinue/stop using/delete existing value(s) and/or the associated functionalit(ies).

X. Implementation 10: Configure Multiple Pre-Configured AD sets

In some implementations, the UE 104 can receive N sets (e.g., a certain number of sets) of assistance data. Each set of assistance data can include, be associated with, or correspond to an ID. The N can be greater than or equal to 1 (e.g., N≥1), where N is a positive integer. In the latter LPP sessions, the LMF can trigger/instruct/indicate for the UE 104 to perform/make/take positioning measurements. Concurrently, the LMF may provide/indicate the ID to the UE 104 indicating which set of assistance data to be utilized in the LPP session. For instance, the LMF can associate/link the ProvideAssistanceData and RequestLocationInformation for flexible scheduling and latency reduction/minimization.

In further example, the UE 104 can receive multiple sets of assistance data in ProvideAssistanceData IE via broadcast or dedicated signaling. Each set can correspond to a unique ID. The UE 104 can store and/or maintain the unique ID and/or the set of assistance data. In at least one latter LPP session, the LMF can send/provide the RequestLocationInformation (e.g., a message) containing/including at least one identifier to the UE 104. Upon receiving the message, the UE 104 can utilize the assistance data associated with the respective ID in the particular or current LPP session. In another latter LPP session, the LMF can send RequestLocationInformation (e.g., a message) containing another ID associated with a different set of assistance data to the UE 104. Responsive to receiving the message (e.g., RequestLocationInformation), the UE 104 can utilize the assistance data associated with the ID of the LPP session (e.g., the latter LPP session). In this case, the N sets of assistance data can be delivered/indicated/provided to the UE 104 through/via broadcasting or LPP dedicate signaling.

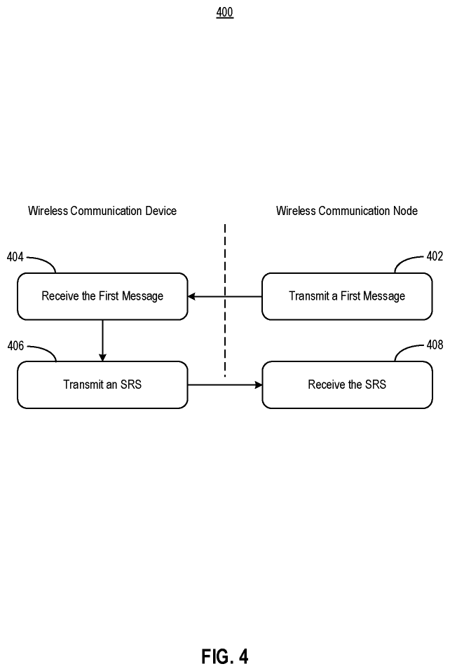

Referring to FIG. 4, depicted is a flow diagram of an example method 400 for positioning using SRS configuration, in accordance with an embodiment of the present disclosure. The method 400 may be implemented using any of the components and devices detailed herein in conjunction with FIGS. 1-2. The method 400 may include operations/techniques/features/functionalities similar to/as part of/in addition to operations described in conjunction with at least FIG. 3, among other descriptions herein. In overview, the method 400 can include transmitting a first message (402). The method 400 can include receiving the first message (404). The method 400 can include transmitting an SRS (406). The method 400 can include receiving the SRS (408).

Referring now to operation (402), and in some implementations, the wireless communication node (e.g., gNB, BS, or node) can transmit a first message to a wireless communication device (e.g., UE). The first message can indicate/include/provide various/multiple Sounding Reference Signal (SRS) aggregates. Each of the SRS aggregates can be associated with a cell ID. At operation (404), the wireless communication device can receive the first message from the wireless communication node.

In some cases, each of the SRS aggregates can include one of at least an SRS configuration, an SRS resource set, and/or an SRS resource, among others. In some cases, the first message may indicate a cell list containing the cell IDs of the respective SRS aggregates. The cell IDs can be associated with individual cells, respectively, such as in a Radio Access Network (RAN)-based Notification Area (RNA).

In some implementations, the wireless communication device can report/provide/indicate a maximum/total number of the SRS aggregates that the wireless communication device can support/handle to the wireless communication node. The maximum number of SRS aggregates may be predetermined/predefined based on the capability of the respective wireless communication device. In some cases, the wireless communication device can provide the capability of the wireless communication device to the wireless communication node, such that the wireless communication node can determine the maximum number of SRS aggregates capable of being supported, for example.

In some cases, the cell ID can include at least one of a Physical Cell Identifier (PCI) or an NCGI (New Radio (NR) Cell Global Identifier). In some cases, the wireless communication device can receive the plurality of SRS aggregates of one or more NG-RAN nodes from the wireless communication node, where the wireless communication node receives the plurality of SRS aggregates from a wireless communication element. For example, the wireless communication node may receive the SRS aggregates (or an indication of the SRS aggregates) that are configured by the wireless communication element based on a respective SRS aggregate. In this case, the one or more NG-RAN nodes can be within an RNA or a pre-configured NG-RAN node list.

At operation (406), the wireless communication device can transmit/send/provide/communicate an SRS according to at least one of the SRS aggregates to the wireless communication node. Accordingly, at operation (408), the wireless communication node can receive the SRS from the wireless communication device.

In some implementations, the wireless communication device may receive a second message indicating the wireless communication device to enter to RRC_CONNECTED state, while receiving no further SRS aggregate from the wireless communication node. The second message may or may not be different from the first message received from the wireless communication node. In some cases, responsive to or subsequent to receiving the second message, the wireless communication device can determine to continue sending the SRS to the wireless communication node according to or following one of the SRS aggregates that the wireless communication device applied/established in a latest/most recent/previous RRC_CONNECTED state.

In some implementations, the responsive to receiving the second message, the wireless communication device can determine to continue sending/communicating/providing the SRS to the wireless communication node according to, based on, or following one of the SRS aggregates that the wireless communication device applied in a latest RRC_INACTIVE state or RRC_IDLE state. The RRC_INACTIVE state may correspond to or refer to the RRC_IDLE state. In some other cases, the wireless communication device can determine not to send the SRS to the wireless communication node (e.g., stop or prevent sending SRS).

In some implementations, the wireless communication device can receive a third message indicating whether the wireless communication device is to or should send the SRS to the wireless communication node during/at an upcoming RRC_INACTIVE period or RRC_IDLE period from the wireless communication node. The third message may or may not be the same as the first message and/or the second message. In this case, the third message can be included/contained/embedded/provided/indicated in a paging Downlink Control Information (DCI). In some cases, the third message may be included in a Radio Resource Control Release (RRCRelease) message with suspension configuration (e.g., SuspendConfig). In some cases, the third message may be included in Small Data Transmission (SDT) Downlink (DL) Radio Resource Control (RRC) message.

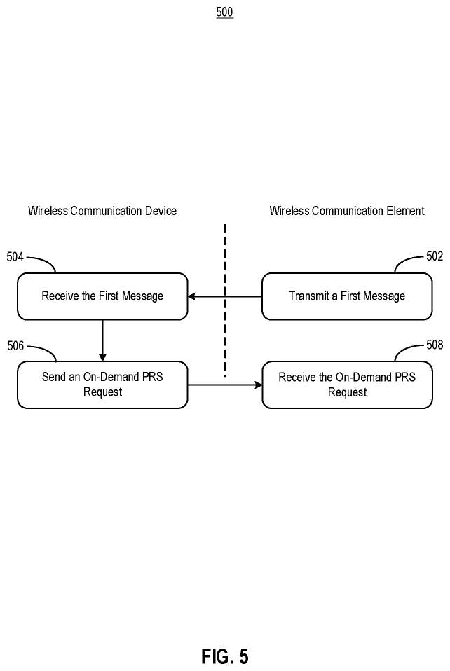

Referring to FIG. 5, depicted is a flow diagram of an example method 500 for positioning using positioning reference signal (PRS) configuration. The method 500 may be implemented using any of the components and devices detailed herein in conjunction with FIGS. 1-2. The method 500 may include operations/techniques/features/functionalities similar to/as part of/in addition to operations described in conjunction with at least FIG. 3, among other descriptions herein. In overview, the method 500 can include transmitting a first message (502). The method 500 can include receiving the first message (504). The method 500 can include sending an on-demand PRS request (506). The method 500 can include receiving the on-demand PRS request (508).

Referring now to operation (502), and in some implementations, a wireless communication element (e.g., LMF) can transmit a first message to a wireless communication device (e.g., UE). The first message can indicate indicating various/multiple Positioning Reference Signal (PRS) configurations. Each of the PRS configurations can be associated with an ID. At operation (504), the wireless communication device can receive the first message from the wireless communication node.

In some implementations, each of the PRS configurations can include multiple elements. In this case, each of the elements can be associated with a respective frequency layer. In some implementations, the first message can be broadcasted by a wireless communication node (e.g., gNB, BS, or node).

At operation (506), the wireless communication device can send/provide/transmit/communicate an on-demand PRS request selecting one or more of the PRS configurations to the wireless communication element. At operation (508), the wireless communication element can receive the on-demand PRS request from the wireless communication device.

In some implementations, the on-demand PRS request can include the respective ID of each of the PRS configurations. In some implementations, the wireless communication device can receive a second message indicating various additional PRS configurations from the wireless communication element. Each of the additional PRS configurations can be associated with an ID and include one or more dynamically configurable PRS parameters. The second message may be the same as or different from the first message, such as including one or more similar or different elements, features, or information, for example.

In some implementations, the wireless communication device can receive a third message from the wireless communication element. The third message may indicate various selected PRS index lists. In this case, each of the selected PRS index lists can be associated with a respective one of multiple positioning methods. In certain cases, the third message may include one or more information or elements similar to or different from the first message and/or the second message. In some aspects, one of the selected PRS index lists can be or correspond to one of the PRS configurations, such as a PRS configuration that is associated with the same positioning method. In some cases, a subset of one of the selected PRS index lists can be or correspond to one of the PRS configurations, such as a PRS configuration associated with a same positioning method.

In some implementations, the wireless communication device may expect to receive the first message in response to not receiving a third message indicating the various selected PRS index lists from the wireless communication element. In some implementations, the wireless communication device may be expected not to receive the first message in response to receiving a third message indicating multiple selected PRS index lists from the wireless communication element.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a location management function (LMF) from a wireless communication node, a positioning information response that comprises a plurality of sounding reference signal (SRS) configurations.
wherein each of the plurality of SRS configurations comprises at least one respective physical cell identity (PCI) and at least one respective new radio (NR) cell global identifier (CGI).

2. The wireless communication method of claim 1, wherein the wireless communication node sends to a wireless communication device, a first message indicating a plurality of Sounding Reference Signal (SRS) aggregates, wherein each of the plurality of SRS aggregates is associated with a cell identifier, and
receives, from the wireless communication device, an SRS according to at least one of the SRS aggregates.

3. The wireless communication method of claim 2, wherein the SRS aggregates each includes an SRS configuration.

4. The wireless communication method of claim 2, wherein the first message further indicates a cell list containing the cell identifiers of the plurality of SRS aggregates.

5. The wireless communication method of claim 1, wherein a wireless communication device associates an on-demand request with a positioning reference signal (PRS) index list for a positioning method corresponding to a PRS configuration.

6. A wireless communication method, comprising:
transmitting, by a wireless communication node to a location management function (LMF), a positioning information response that comprises a plurality of sounding reference signal (SRS) configurations.
wherein each of the plurality of SRS configurations comprises at least one respective physical cell identity (PCI) and at least one respective new radio (NR) cell global identifier (CGI).

7. The wireless communication method of claim 6, comprising:
transmitting, by the wireless communication node to a wireless communication device, a first message indicating a plurality of Sounding Reference Signal (SRS) aggregates, wherein each of the plurality of SRS aggregates is associated with a cell identifier; and
receiving, by the wireless communication node from the wireless communication device, an SRS according to at least one of the SRS aggregates.

8. The wireless communication method of claim 7, wherein the SRS aggregates each includes an SRS configuration.

9. The wireless communication method of claim 7, wherein the first message further indicates a cell list containing the cell identifiers of the plurality of SRS aggregates.

10. The wireless communication method of claim 6, wherein a wireless communication device associates an on-demand request with a positioning reference signal (PRS) index list for a positioning method corresponding to a PRS configuration.

11. A location management function (LMF), comprising: at least one processor configured to:
receive, via a receiver from a wireless communication node, a positioning information response that comprises a plurality of sounding reference signal (SRS) configurations.
wherein each of the plurality of SRS configurations comprises at least one respective physical cell identity (PCI) and at least one respective new radio (NR) cell global identifier (CGI).

12. The LMF of claim 11, wherein the wireless communication node sends to a wireless communication device, a first message indicating a plurality of Sounding Reference Signal (SRS) aggregates, wherein each of the plurality of SRS aggregates is associated with a cell identifier, and
receives, from the wireless communication device, an SRS according to at least one of the SRS aggregates.

13. The LMF of claim 12, wherein the SRS aggregates each includes an SRS configuration.

14. The LMF of claim 12, wherein the first message further indicates a cell list containing the cell identifiers of the plurality of SRS aggregates.

15. The LMF of claim 11, wherein a wireless communication device associates an on-demand request with a positioning reference signal (PRS) index list for a positioning method corresponding to a PRS configuration.

16. A wireless communication node, comprising: at least one processor configured to:
transmit, via a transceiver to a location management function (LMF), a positioning information response that comprises a plurality of sounding reference signal (SRS) configurations.
wherein each of the plurality of SRS configurations comprises at least one respective physical cell identity (PCI) and at least one respective new radio (NR) cell global identifier (CGI).

17. The wireless communication node of claim 16, wherein the at least one processor is configured to:
transmit, via the transceiver to a wireless communication device, a first message indicating a plurality of Sounding Reference Signal (SRS) aggregates, wherein each of the plurality of SRS aggregates is associated with a cell identifier; and
receive, via the transceiver from the wireless communication device, an SRS according to at least one of the SRS aggregates.

18. The wireless communication node of claim 17, wherein the SRS aggregates each includes an SRS configuration.

19. The wireless communication node of claim 17, wherein the first message further indicates a cell list containing the cell identifiers of the plurality of SRS aggregates.

20. The wireless communication node of claim 16, wherein a wireless communication device associates an on-demand request with a positioning reference signal (PRS) index list for a positioning method corresponding to a PRS configuration.
